(19) United States
(12) Patent Application Publication
(10) Pub. No.: US 2022/0026906 A1
(43) Pub. Date: Jan. 27, 2022

(54) SYSTEM AND A METHOD FOR VALIDATING OCCURRENCE OF EVENTS

(71) Applicant: INDOOR ROBOTICS LTD., RAMAT-GAN (IL)

(72) Inventors: DORON BEN-DAVID, RAMAT-GAN (IL); AMIT MORAN, TEL-AVIV (IL)

(21) Appl. No.: 16/935,229

(22) Filed: Jul. 22, 2020

(51) Int. Cl. G05D 1/00; G05D 1/02

(52) U.S. Cl. CPC G05D 1/0094; G05D 1/0291

(57) ABSTRACT

A computerized method including collecting information by a sensor unit, identifying an option for occurrence of an event based on the collected information, sending a command to a first mobile robot to move to a validation location, where presence of the first mobile robot in the validation location enables the first mobile robot to validate the occurrence of the event, the first mobile robot moving to the validation location, the first mobile robot validating the occurrence of the event.

### FIELD

The invention relates to a validating occurrence of events detected by sensors.

### BACKGROUND

The automated world increases usage in sensors, to facilitate life. These sensors may be image sensors for capturing images, temperature sensors, humidity sensors, audio sensors, LIDAR sensors, computerized devices which detect occurrence of physical events, such as passing an identifiable device or card near an identifying device and the like. The sensors may transmit the collected information to another device, for example a server having processing capabilities, or process the collected information locally at the sensor. Processing the collected information may result in identifying an event, such as a presence of a person or object in a specific area in which the sensor collects the information. The area may be a room, yard, warehouse, or a portion thereof. The event may be a presence of the object in a certain part of a warehouse at 22:15. The event may be detection of human sound, or wind, which may imply that a wind or door were left open. An event may be a leakage of a material. In some cases, the same circumstance may be considered an event to be handled only during some time, for example presence of persons in the office on a weekend may be considered an event, while presence of persons in the same space during working hours does not initiate an event to be handled. However, information collected by sensors may result in false positive events, and require attention from personnel, such as guards, even when there is no need. Such attention results in more personnel than actually necessary to maintain functional and security requirements of a facility, such as a building, warehouse, restricted area, office and the like.

### SUMMARY

In one aspect of the invention a computerized method is provided including collecting information by a sensor unit, identifying an option for occurrence of an event based on the collected information, sending a command to a first mobile robot to move to a validation location, wherein presence of the first mobile robot in the validation location enabling the first mobile robot to validate the occurrence of the event, the first mobile robot moving to the validation location, the first mobile robot validating the occurrence of the event.

In some cases, the sensor unit identifies the option for occurrence of an event.

In some cases, the method further includes the sensor unit sending the collected information to a remote device, wherein the remote device identifies the option for occurrence of an event. In some cases, the remote device is the first mobile robot. In some cases, the method further includes the first mobile robot sending a validation signal to a remote device, said validation signal indicating whether or not the event took place.

In some cases, the method further includes selecting a second mobile robot from multiple mobile robots, sending the validation signal to the selected second mobile robot, wherein the validation signal comprises details of a mission to be performed by the second mobile robot in response to the validated event.

In some cases, the method further includes generating a mission to be performed based on the validation signal. In some cases, the method further includes performing the mission by the first mobile robot.

In some cases, the method further includes updating the validation location and sending a command to the mobile robot to move to a new validation location. In some cases, identifying the option for occurrence of the event comprises comparing the collected information to prior information collected by the sensor unit.

In some cases, the sensor unit includes multiple sensors, wherein the method further comprising determining the validation location based on a specific sensor of the multiple sensors, said specific sensor collected the information that resulted in the option for occurrence of the event.

In some cases, the event includes access to a location or a device. In some cases, the event comprises presence of a person in a location. In some cases, the event comprises failure of a device. In some cases, the sensor that collected the information is carried by a second mobile robot, wherein the second mobile robot is distinct from the first mobile robot.

In some cases, the sensor identifies the option for occurrence of the event, wherein a processor extracts information from additional sensors, wherein the processor determines whether or not to send the first mobile robot to the validation location based on the information received from the additional sensors.

In some cases, the method further includes the sensor estimating a movement of an object associated with the event, said sensor sending information associated with the movement of the object, computing a new validation location based on the information associated with the movement of the object, and sending the new validation location to the first mobile robot.

In some cases, the method further includes the first mobile robot detecting another object preventing or limiting the first mobile robot's movement towards the validation location and the mobile robot sending a signal to another robot to move the object.

### BRIEF DESCRIPTION OF THE DRAWINGS

The invention may be more clearly understood upon reading of the following detailed description of non-limiting exemplary embodiments thereof, with reference to the following drawings, in which:

FIG. 1 shows a computerized environment having multiple mobile robots and multiple dock stations, according to exemplary embodiments of the subject matter.

FIG. 2 shows schematic components of a mobile robot, according to exemplary embodiments of the disclosed subject matter.

FIG. 3 shows a method for validating occurrence of an event using one or more mobile robots, according to exemplary embodiments of the disclosed subject matter.

FIG. 4 shows a method for identifying a mission to be performed by one or more mobile robots after validation of the event, according to exemplary embodiments of the disclosed subject matter.

FIG. 5 shows a method for predicting movement of an object associated with the event and adjusting location of mobile robot sent to validate the event, according to exemplary embodiments of the disclosed subject matter.

FIG. 6 shows a method for handling option for occurrence of the event based on severity value of the event, according to exemplary embodiments of the disclosed subject matter.

FIG. 7 shows an environment for a mobile robot to validate an event based on information collected by a sensor, according to exemplary embodiments of the disclosed subject matter.

The following detailed description of embodiments of the invention refers to the accompanying drawings referred to above. Dimensions of components and features shown in the figures are chosen for convenience or clarity of presentation and are not necessarily shown to scale. Wherever possible, the same reference numbers will be used throughout the drawings and the following description to refer to the same and like parts.

### DETAILED DESCRIPTION

Illustrative embodiments of the invention are described below. In the interest of clarity, not all features/components of an actual implementation are necessarily described.

The subject matter in the invention discloses a system and method for validating events occurring in an area. The sensors in the area collect information, as elaborated below. The collected information may be translated into an option of occurrence of an event, for example when exceeding a threshold or matching a rule. When there is an option for occurrence of an event, a command is sent to a mobile robot to move to a location enabling the robot to validate the event. Such location is defined as a validation location. After validating the event, the mobile robot may send a signal indicating whether or not the event took place. The mobile robot may also generate a mission in response to the occurrence of the event. The mission may be generated by another device. Validation of an event is defined by verifying that the event took place. The validation may be computed by a robot, a sensor or a central control device. The validation may be defined as increasing the probability that the event took place to a percentage higher than a threshold, for example over 98.5%.

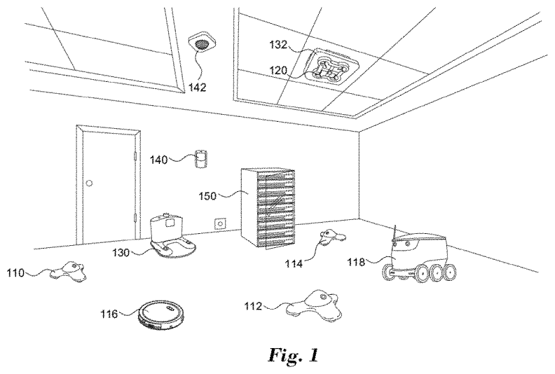

FIG. 1 disclose a computerized environment having multiple mobile robots and multiple dock stations, according to exemplary embodiments of the subject matter. The mobile robots 110, 112, 114, 116, 118 and 120 comprise an actuation mechanism enabling independent movement of the mobile robots. In other words, the robots' movement does not require a third party moving the robots from one place to another. The term “robot” as used below is defined as a “mobile robot” capable of moving independently. The mobile robots 110, 112, 114, 116, 118 and 120 also include a power source, for example connection to the electricity grid, a battery, a solar panel and charger and the like. The battery may be charged by a dock station, selected from dock stations 130, 132.

Each dock station of dock stations 130, 132 may enable one or more of the mobile robots 110, 112, 114, 116, 118 and 120 to dock thereto. Docking may provide the mobile robots 110, 112, 114, 116, 118 and 120 with electrical voltage, in case the dock stations 130, 132 are coupled to a power source. The dock stations 130, 132 may have network connectivity, such as a cellular modem or internet gateway, enabling the dock stations 130, 132 to transfer information from the mobile robots 110, 112, 114, 116, 118 and 120 to a remote device such as a server or a central control device 150. In some other cases, the mobile robots may be connected to an internet gateway. The dock stations 130, 132 may be secured to a wall, a floor, the ceiling, or to an object in the area, such as a table. The dock stations 130, 132 may be non-secured dock-stations, for example a mobile robot with a big battery or an extension cord connected to the mobile robot may function as a dock station, charging another robot.

The central control device 150 may be a computer, such as a laptop, personal computer, server, tablet computer and the like. The central control device 150 may be an online service stored on a cloud, may be located on at least one of the robots or the dock stations. The central control device 150 may store a set of rules enabling to decide which of the mobile robots to be sent to perform a mission. The central control device 150 may comprise an input unit enabling users to input missions therein. The input unit may be used to input constraints, such as maximal number of missions per time unit. The central control device 150 may be coupled to at least a portion of the mobile robots 110, 112, 114, 116, 118 and 120, for example in order to send commands to the robots, to receive a location of the robots, and additional information, such as technical failure of a component in the robot, battery status, mission status and the like. In some cases, the computerized environment lacks the central control device 150, and one or more of the mobile robots 110, 112, 114, 116, 118 and 120 perform the tasks described with regard to the central control device 150.

The computerized environment may also comprise a sensor unit comprising one or more sensors 140, 142. The sensors 140, 142 may be image sensors for capturing images, temperature sensor, humidity sensor, audio sensor, door or window opening sensor, LIDAR sensor and the like. The sensors 140, 142 of the sensor unit may be secured to a certain object, such as a wall, shelf, table, ceiling, floor and the like. The sensors 140, 142 of the sensor unit may collect information at a sampling rate and send the collected information to the central control device 150. The sensors 140, 142 of the sensor unit may have a processing unit which determines whether or not to send the collected information to the remote device, such as to one or more of the mobile robots 110, 112, 114, 116, 118 and 120 or the central control device 150.

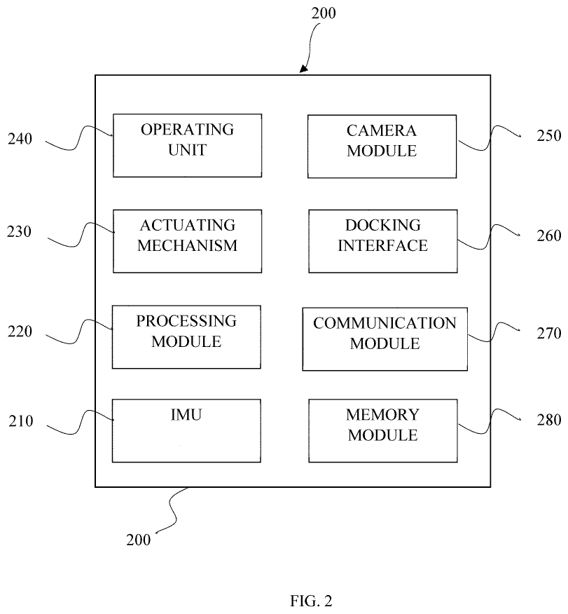

FIG. 2 shows schematic components of a mobile robot, according to exemplary embodiments of the disclosed subject matter. The mobile robot 200 comprises an operating unit 240 dedicated to performing a mission. The operating unit 240 may comprise one or more arms or another carrying member for carrying an item. The carrying member may be a magnetic plate for securing a metallic object. The operating unit 240 may comprise a container for containing a material, for example water, paint, sanitation material, perfume, beverages, a cleaning material, in case the mission is to provide a material to a certain place or person. The operating unit 240 may be a sensor for sensing information in a certain location, said sensor may be an image sensor, audio sensor, temperature sensor, odor sensor, smoke sensor, fire detector, air quality sensor, sensor for detecting presence of a material and the like.

The mobile robot 200 comprises an actuation mechanism 230 for moving the mobile robot 200 from one place to another. The actuation mechanism 230 may comprise a motor, an actuator and any mechanism configured to maneuver a physical member. The actuation mechanism 230 may comprise a rotor of some sort, enabling the mobile robot 200 to fly. The actuation mechanism 230 is coupled to a power source, such as a battery or a renewable energy member, such as a solar panel in case the area comprises or is adjacent to an outdoor area accessible to the mobile robot 200. The actuation mechanism 230 may move the mobile robot 200 in one, two or three dimensions, for example horizontally or vertically.

The mobile robot 200 may also comprise an inertial measurement unit (IMU) 210 configured to measure the robot's linear acceleration and angular velocities. The measurements collected by the IMU 210 may be transmitted to a processing module 220 configured to process the measurements. The IMU 210 may comprise one or more sensors, such as an accelerator, a gyroscope, a compass or magnetometer, a barometer and any the like.

The processing module 220 is configured to control the missions, and other actions, performed by the mobile robot 200. Thus, the processing module 220 is coupled to the actuation mechanism 230 configured to move the mobile robot 200. Such coupling may be via an electrical channel or cable, wireless communication, magnetic-based communication, optical fibers and the like. The processing module 220 may send a command to the actuation mechanism 230 to move to a certain location associated with a mission. The command may include instructions as to how to move to the certain location. The processing module 220 as defined herein may be a processor, controller, microcontroller and the like. The processing module 220 may be coupled to a communication module 270 via which the missions are received at the mobile robot 200. The communication module 270 may be configured to receive wireless signals, such as RF, Bluetooth, Wi-Fi and the like. The mobile robot 200 may also comprise a camera module 250 including one or more cameras for capturing images and/or videos.

The mobile robot 200 may comprise a memory module 280 configured to store information. For example, the memory module 280 may store prior locations of the mobile robot 200, battery status of the mobile robot 200, mission history of the mobile robot 200 and the like. The processing module 220 may sample one or more memory addresses of the memory module 280 to identify alerts to be sent to a remote device. Such alert may be low battery, failure of the operation unit 240 and the like. Such alert may be sent via the communication module 270. Such remote device may be a dock station or a server, such as a web server.

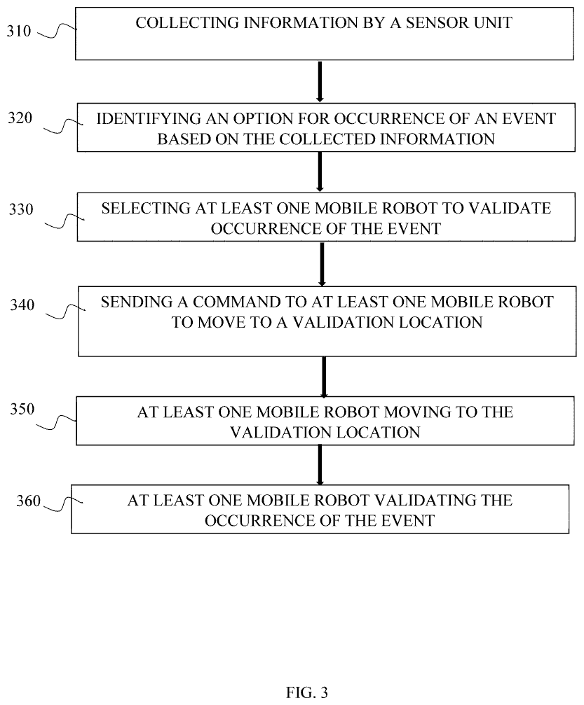

FIG. 3 shows a method for validating occurrence of an event using one or more mobile robots, according to exemplary embodiments of the disclosed subject matter.

Step 310 discloses collecting information by a sensor unit. The sensor may be one or more image sensors for capturing images, temperature sensor, humidity sensor, audio sensor, odor sensor, sensor for detecting presence of a material and a combination thereof. The collected information may be sent to the processor. In some cases, the information is sent to the processor only in case the value measured exceeds a threshold, or matches a condition.

Step 320 discloses identifying an option for occurrence of an event based on the collected information. The option may be defined by a rule, for example a presence of a person or object in an area may be identified as an event only in some hours during the day. The hours may be stored in a memory of the sensor, one of the mobile robots, or a central control device. The event may be detection of noise, which may be defined as an option for an event, as the event is a presence of persons, or an open window. Identifying the option for occurrence of the event may be performed by a sensor, by a central control device, by one of the mobile robots. In some exemplary embodiments, the option for occurrence of an event may be identified in response to collecting information by multiple sensors. For example, in case a single sensor does not suffice to send the robot to the validation location.

Step 330 discloses selecting at least one mobile robot to validate occurrence of the event. The selected mobile robot may be the closest mobile robot, in case there are multiple mobile robots in the area. The selected mobile robot may be selected based on matching between the mobile robots' skills and the optional event, to enable handling the event by the mobile robot that validated it. Selection of the mobile robot may be performed by multiple mobile robots that exchange information in a distributed manner. In some other cases, the first mobile robot that suggests to validate the event is selected.

Step 340 discloses sending a command to at least one mobile robot to move to a validation location. The command may be sent on a wireless manner, for example over the internet, Bluetooth, cellular network and the like. The command may reach a dock station in which the selected mobile robot docks while the command is sent. The command may be sent as an output of a function used to select the robot. The command may be outputted from another mobile robot, from a sensor unit, or from a central control device. The command may include an event type and validation location, directing the mobile robot to a location enabling the mobile robot to validate the occurrence of the event.

Step 350 discloses at least one mobile robot moving to the validation location. There may be one mobile robot selected to validate the occurrence of the event, or multiple mobile robots selected for that mission. in case there are multiple mobile robots, their movement may be synchronized, in order for the multiple mobile robots to reach the validation location together, or within a period of time such as 1.5 seconds. In case there is another object preventing or limiting the mobile robot's movement towards the validation location, the mobile robot may send a signal to another device to move that object. The device moving the object may be held by a person who should move the object.

Step 360 discloses at least one mobile robot validating the occurrence of the event. Validation may be performed using a camera, capturing an image, and processing that the image, or a sequence of images, contains a person, an object, or a state of an object, such as an open door or window. This way, validation may comprise processing information collected by the mobile robot. Such processing may be performed by the robot who captured the image, or by another device, such as a server or a central control device. Validation, as a whole, may be performed by the mobile robot. In some other cases, the mobile robot collects validating information which is later used to validate the event. The validating information may be processed locally at the mobile robot that collected the validating information or by a remote device.

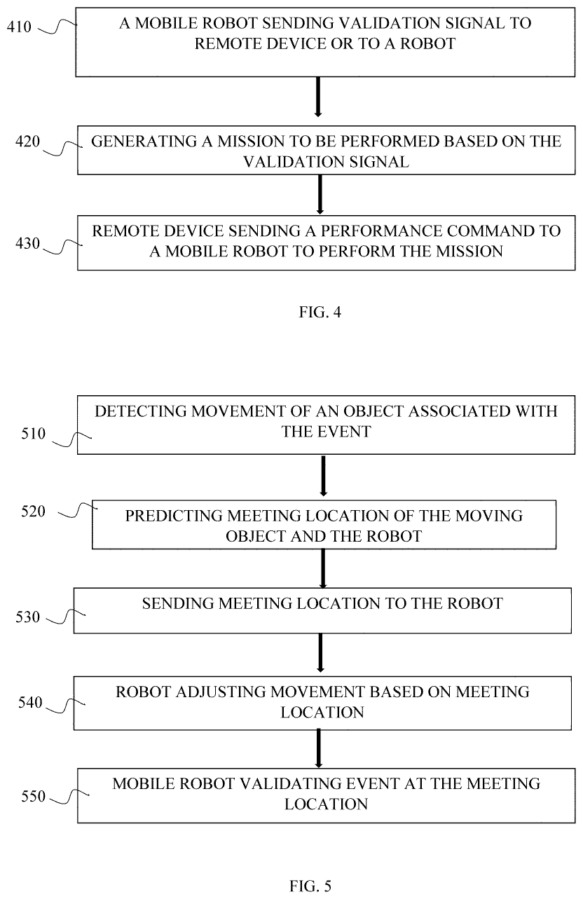

FIG. 4 shows a method for identifying a mission to be performed by one or more mobile robots after validation of the event, according to exemplary embodiments of the disclosed subject matter.

Step 410 discloses a mobile robot sending a validation signal to a remote device or to a robot. The validation signal indicates whether or not there is an event based on the information collected by the sensor. The validation signal may comprise additional information about the event, such as number of people identified, size of object captured, odor, temperature and the like. The validation signal may be a wireless signal sent to another device. The validation signal may be an audible or otherwise sensible alert outputted from the mobile robot. In some exemplary cases, the same robot that validated the event also handles the mission generated in response to the event. In such cases, the validation signal may be confirmation that the mobile robot is occupied in performing a mission.

Step 420 discloses generating a mission to be performed based on the validation signal. The mission may be added to a database of missions, for example a list, stored in a computerized memory. The mission may be associated with a mission type, mission location, mission duration and the like. The mission may be generated by the robot that validated the occurrence of the event, by a central control device, or cooperatively using multiple devices, such as multiple robots. In some cases, the robot that validated the event generates the mission and sends a signal to another robot to perform the mission. That is, the first robot also chooses the second robot to perform the mission.

Step 430 discloses remote device sending a performance command to a mobile robot to perform the mission. The performance command is sent to the selected mobile robots to perform the mission. the command may be sent over the internet. The command may be sent to a dock station in which the mobile robot is currently docking. The command may be sent via an RF or a Bluetooth protocol.

FIG. 5 shows a method for predicting movement of an object associated with the event and adjusting location of mobile robot sent to validate the event, according to exemplary embodiments of the disclosed subject matter.

Step 510 discloses detecting movement of an object associated with the event. The movement may be detected based on noise generated due to movement of the object, based on images captured by a sensor, based on a signal strength of a signal emitted from the object, and the like. The object may be a person, an animal, a robot, an object having an actuator, an object that can be carried by a person or robot and the like. The movement may be defined by velocity, direction or a combination of both. For example, 2.3 m/s towards the southern wall.

Step 520 discloses predicting meeting location of the moving object and the robot. The meeting location considers the movement of the object, location of the object when the object's movement was detected, robot's location and velocity. Then, the shortest path the robot should do to meet the object may be computed, or another path to meet the object. Then, the robot will receive instructions, such as “move 3 meters, then turn right and move 12 meters at maximal speed” or receive a destination and the calculation will be performed on the robot.

Step 530 discloses sending meeting location to the robot. The meeting location may be sent over a wireless channel from the entity that computed it. The meeting location may be computed locally by the robot selected to validate the occurrence of the event. In such case, there is no need to send the meeting location.

Step 540 discloses robot adjusting movement based on meeting location. Adjusting the movement may include adjusting a movement direction of the mobile robot, adjusting velocity of the mobile robot's movement or a combination of both.

Step 550 discloses mobile robot validating event at the meeting location. Validation may be performed using a camera, capturing an image, and processing that the image, or a sequence of images, contains a person, an object, or a state of an object, such as an open door or window. This way, validation may comprise processing information collected by the mobile robot. Such processing may be performed by the robot who captured the image, or by another device, such as a server or a central control device. Validation, as a whole, may be performed by the mobile robot. In some other cases, the mobile robot collects validating information which is later used to validate the event. The validating information may be processed locally at the mobile robot that collected the validating information or by a remote device.

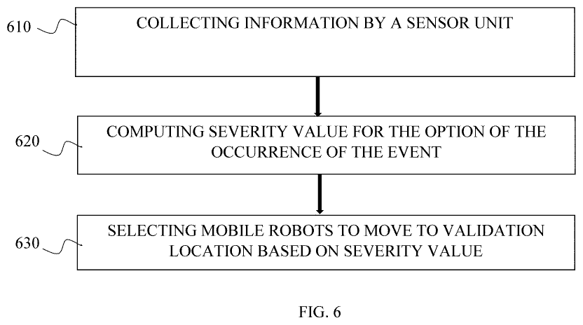

FIG. 6 shows a method for handling option for occurrence of the event based on severity value of the event, according to exemplary embodiments of the disclosed subject matter.

Step 610 discloses collecting information by a sensor unit. The sensor may be one or more image sensors for capturing images, temperature sensor, humidity sensor, audio sensor, odor sensor, sensor for detecting presence of a material and a combination thereof. The collected information may be sent to the processor. In some cases, the information is sent to the processor only in case the value measured exceeds a threshold, or matches a condition.

Step 620 discloses computing severity value for the option of the occurrence of the event. The severity value may be an output of a function receiving as input at least one of the following properties—the measurements collected by the sensor unit, the location of the option of the occurrence of the event, the event type, potential damage of occurrence of the event, event alert rank, number of sensors that collected the information and the like. The severity value may be computed locally by a sensor, by one or more of the mobile robots or by a central control device.

Step 630 discloses selecting mobile robots to move to validation location based on severity value. For example, in case of a higher severity value, most of the mobile robots will be sent to the validation location, to increase the chances that the event, if validated, is handled. This is especially relevant in case multiple mobile robots have different sets of skills, for example one mobile robot carries water to handle fire incidents, and another mobile robot comprises advanced image processing capabilities. The selection of the one or more mobile robots to validate the occurrence of the event may be performed by a sensor, by one or more of the mobile robots or by a central control device.

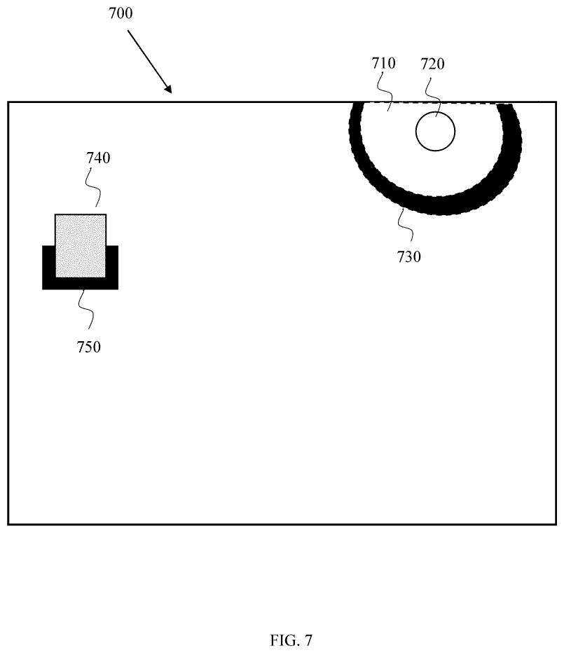

FIG. 7 shows an environment for a mobile robot to validate an event based on information collected by a sensor, according to exemplary embodiments of the disclosed subject matter. The environment may operate inside an area 700, such as a building, yard, warehouse, school, factory, military zone, rural area, agricultural facility, and the like. The area 700 shows a sensor 720 located near one of the edges of the area. The sensor collects information in a sensed area 710, for example based on walls inside the area 700 and technical properties of the sensor 720. The area 700 also shows a mobile robot 740 that may be secured to a dock station 750. When the sensor 720 detects an option of occurrence of an event in the sensed area 710, a command is sent to the mobile robot 740 to check whether or not an event actually occurs in the sensed area 710. The mobile robot 740 then moves to a validation location, which may be the sensed area 710, or a validation area 730, which is an area near the sensed area 710. In some cases, the validation area 730 is defined as an area in which the sensor 720 that detects an option for the occurrence of the event cannot collect information. For example, the sensor 720 cannot capture images of the validation area 730 when the sensor 720 is located in place.

It should be understood that the above description is merely exemplary and that there are various embodiments of the invention that may be devised, mutatis mutandis, and that the features described in the above-described embodiments, and those not described herein, may be used separately or in any suitable combination; and the invention can be devised in accordance with embodiments not necessarily described above.

What is claimed is:

1. A computerized method, comprising:
collecting information by a sensor unit;
identifying an option for occurrence of an event based on the collected information;
sending a command to a first mobile robot to move to a validation location, wherein presence of the first mobile robot in the validation location enabling the first mobile robot to validate the occurrence of the event;
the first mobile robot moving to the validation location; and
the first mobile robot validating the occurrence of the event.

2. The method of claim 1, wherein the sensor unit identifies the option for occurrence of an event.

3. The method of claim 1, further comprising the sensor unit sending the collected information to a remote device, wherein the remote device identifies the option for occurrence of an event.

4. The method of claim 3, wherein the remote device is the first mobile robot.

5. The method of claim 1, further comprising the first mobile robot sending a validation signal to a remote device, said validation signal indicating whether or not the event took place.

6. The method of claim 5, further comprising:
selecting a second mobile robot from multiple mobile robots; and
sending the validation signal to the selected second mobile robot, wherein the validation signal comprises details of a mission to be performed by the second mobile robot in response to the validated event.

7. The method of claim 5, further comprising generating a mission to be performed based on the validation signal.

8. The method of claim 7, further comprising performing the mission by the first mobile robot.

9. The method of claim 1, further comprising updating the validation location and sending a command to the mobile robot to move to a new validation location.

10. The method of claim 1, wherein identifying the option for occurrence of the event comprises comparing the collected information to prior information collected by the sensor unit.

11. The method of claim 1, wherein the sensor unit comprises multiple sensors, and wherein the method further comprising determining the validation location based on a specific sensor of the multiple sensors, said specific sensor collected the information that resulted in the option for occurrence of the event.

12. The method of claim 1, wherein the event comprises access to a location or a device.

13. The method of claim 1, wherein the event comprises presence of a person in a location.

14. The method of claim 1, wherein the event comprises failure of a device.

15. The method of claim 1, wherein the sensor that collected the information is carried by a second mobile robot, wherein the second mobile robot is distinct from the first mobile robot.

16. The method of claim 1, wherein the sensor identifying the option for occurrence of the event, wherein a processor extracts information from additional sensors, wherein the processor determines whether or not to send the first mobile robot to the validation location based on the information received from the additional sensors.

17. The method of claim 1, further comprising:
the sensor estimating a movement of an object associated with the event; said sensor sending information associated with the movement of the object;
computing a new validation location based on the information associated with the movement of the object;
sending the new validation location to the first mobile robot.

18. The method of claim 1, further comprising:
the first mobile robot detecting another object preventing or limiting the first mobile robot's movement towards the validation location;
the mobile robot sending a signal to another robot to move the object.
